(19) United States
(12) Patent Application Publication
(10) Pub. No.: US 2003/0115594 A1
(43) Pub. Date: Jun. 19, 2003

(54) Apparatus and method for processing transport stream in digital cable broadcasting system and delay controlling apparatus for the same

(76) Inventors: Han-Seung Koo, Daejeon (KR); Byung-Jun Bae, Daejeon (KR); Yong-Seong Jo, Jeonju (KR); Jin-hwan Lee, Daejeon (KR); Kwon O-Hyoung, Daejeon (KR); Chieteuk Ahn, Daejeon (KR)

Correspondence Address: JACOBSON HOLMAN PLLC, 400 SEVENTH STREET N.W., SUITE 600, WASHINGTON, DC, 20004, US

(21) Appl. No.: 10/122,217

(22) Filed: Apr. 16, 2002

(30) Foreign Application Priority Data
Dec. 17, 2001 (KR) 2001-80007

(51) Int. Cl. H04N 7/167

(52) U.S. Cl. 725/31

(57) ABSTRACT

Disclosed is an apparatus and method for processing transport streams (TSs) and a delay-controlling apparatus that assigns a predetermined delay to MPEG-2 TS packets fed into a POD module in a digital cable broadcasting system, irrespective of a time delay caused by descrambling scrambled input TS packets, the apparatus including: a demultiplexer for receiving TSs and dividing them into scrambled and non-scrambled data; a descrambler controller for receiving the scrambled data from the demultiplexer and descrambling it; a delay controller for receiving the non-scrambled data from the demultiplexer and the descrambled data from the descrambler controller and delaying them by a predetermined time; and a remultiplexer for receiving the data from the delay controller, multiplexing them, and outputting the multiplexed data in the TS format.

### BACKGROUND OF THE INVENTION

(a) Field of the Invention

The present invention relates to an apparatus and method for processing a transport stream (hereinafter referred to as “TS”) in a digital cable broadcasting system and a delay-controlling apparatus for the same. More specifically, the present invention relates to an apparatus and method for processing a TS and a delay-controlling apparatus for the same that assigns a predetermined delay to all MPEG (Motion Picture Experts Group)-2 TS packets fed into a Point Of Deployment module (hereinafter referred to as “POD module”) in a digital cable broadcasting system, irrespective of a time delay caused by descrambling scrambled input TS packets.

(b) Description of the Related Art

In the recent digital cable broadcasting system, the digital broadcasting stream is carried on an MPEG-2 TS through in-band channels. The TS is fed into the POD module by 8 bits in parallel. The POD module performs TS packet alignment to align the TS in 188 sync bytes and judges whether or not the TS packet is scrambled.

Whether or not the TS packet is scrambled is judged from a 2-bit transport scrambling control field present in the TS packet header. If the transport scrambling control field has a value of “10” or “11”, the TS packet is judged as a scrambled packet; otherwise, if the transport scrambling control field has a value other than “10” or “11”, the TS packet is judged as a non-scrambled packet.

The scrambled packet is descrambled via a descrambler, whereas the non-scrambled packet is passed over without being descrambled.

Conventionally, a demultiplexer built in the POD module performs these procedures, as shown in FIG. 1. A description will now be given of a TS processing apparatus according to prior art, with reference to FIG. 1.

As illustrated in FIG. 1, the conventional TS processing apparatus comprises a demultiplexer 1, a descrambler controller 2, and a remultiplexer 3.

The demultiplexer 1 aligns input TS data TS_DATA_IN in the size of 188 sync bytes. Then the demultiplexer 1 sends the scrambled packet DATA_S to the descrambler controller 2, and the non-scrambled packet DATA_NS directly to the remultiplexer 3 without descrambling. The descrambler controller 2 sends the descrambled packet DATA_S_D to the remultiplexer 3, which converts the TSs that are demultiplexed at the TS processing apparatus to single TS data TS_DATA_OUT, and sends it to a host (not shown).

Namely, the main function of the POD module that processes in-band channel data is to judge whether or not the TS data are scrambled, and to descramble the scrambled TS packets.

But such a selective descrambling of the scrambled TS packets causes time inconsistence between the scrambled TS packets and the non-scrambled TS packets because of a delay during the descrambling process.

The MPEG-2 system requires a delay within ±500 nano-seconds. For a system using a 10 MHz system clock, for example, a delay of 5 clock signals in the descrambler controller 2 exceeds the limit time.

Due to the time delay at the descrambler controller 2, the time inconsistence among all the input TS packets on the in-band channels of the POD module results in a problem during the decoding process.

To solve the problem during the decoding process caused by the delay of a specified packet, the program clock reference (PCR) value in the TS packet is compensated.

However, this method does not meet the requirements of the cable standard and only increases the complexity in the POD module.

### SUMMARY OF THE INVENTION

It is an object of the present invention to provide an apparatus and method for processing a TS and a delay-controlling apparatus for the same that assigns a predetermined delay to all MPEG-2 TS packets fed into a POD module in a digital cable broadcasting system, irrespective of a time delay caused by descrambling scrambled input TS packets.

In one aspect of the present invention, there is provided an apparatus for processing a TS in a digital cable broadcasting system, said apparatus to process a digital cable broadcasting data signal received in a TS format, the apparatus including: a demultiplexer for receiving TSs and dividing them into a scrambled data signal and a non-scrambled data signal; a descrambler controller for receiving the scrambled data signal from the demultiplexer and descrambling it; a delay controller for receiving the non-scrambled data signal from the demultiplexer and the descrambled data signal from the descrambler controller and delaying them by a predetermined time; and a remultiplexer for receiving the data signals from the delay controller, multiplexing them, and outputting the multiplexed data signals in the TS format.

In another aspect of the present invention, there is provided an apparatus for controlling a delay in a digital cable broadcasting system, said apparatus to control the delay for remultiplexing a descrambled data signal that is converted from a scrambled data signal, and a non-scrambled data signal, the apparatus including: a system clock signal controller for receiving first and second valid signals, calculating a predetermined delay time, and generating a system time, the first and second valid signals being valid signals of the scrambled data signal and the non-scrambled data signal, respectively; a time stamp controller for receiving the descrambled data signal, the non-scrambled data signal, and TS valid signals corresponding to the descrambled data signal and the non-scrambled data signal, and generating third and fourth valid signals and the respective data signals, the third and fourth valid signals being generated by regulating the values of the corresponding valid signals according to the system time output from the system clock signal controller; a first output controller for outputting the descrambled data signal received from the time stamp controller when the third valid signal output from the time stamp controller is matched with the system time of the system clock signal controller; and a second output controller for outputting the non-scrambled data signal received from the time stamp controller when the fourth valid signal output from the time stamp controller is matched with the system time of the system clock signal controller.

In another aspect of the present invention, there is provided an apparatus for controlling a delay in a digital cable broadcasting system, said apparatus to control the delay for remultiplexing a descrambled data signal that is converted from a scrambled data signal, and a non-scrambled data signal, the apparatus including: an offset controller for receiving first and second valid signals, calculating a predetermined offset time according to a required descrambling time using a third valid signal, and outputting the predetermined offset time as a system time, the first and second valid signals being valid signals of the scrambled data signal and the non-scrambled data signal, respectively, the third valid signal being a valid signal of the descrambled data signal; a first output controller for storing the descrambled data signal, and outputting it when the third valid signal is matched with the system time output from the offset controller; and a second output controller for storing the non-scrambled data signal, and outputting it when the second valid signal is matched with the system time output from the offset controller.

In still another aspect of the present invention, there is provided an apparatus for controlling a delay in a digital cable broadcasting system, said apparatus to control the delay for remultiplexing a descrambled data signal that is converted from a scrambled data signal, and a non-scrambled data signal, the apparatus including: a first counter controller for receiving a first valid signal, counting for a predetermined time, and generating a first count end signal at the end of counting, the first valid signal being a valid signal of the scrambled data signal; a second counter controller for receiving a second valid signal, counting for a predetermined time, and generating a second count end signal at the end of counting, the second valid signal being a valid signal of the non-scrambled data signal; a first output controller for storing the descrambled data signal, and outputting it upon receiving the first count end signal from the first counter controller; and a second output controller for storing the non-scrambled data signal, and outputting it upon receiving the second count end signal from the second counter controller.

In still another aspect of the present invention, there is provided a method for processing a TS in a digital cable broadcasting system, said method demultiplexing a digital cable broadcasting data signal received in a TS format, descrambling a scrambled signal and remultiplexing the descrambled signal in the TS format, the method including: (a) receiving TSs and dividing them into a scrambled data signal and a non-scrambled data signal; (b) receiving the scrambled data signal and descrambling it; (c) receiving the non-scrambled data signal and the descrambled data signal and delaying them by a predetermined time; and (d) receiving the delayed data signals, multiplexing them, and outputting the multiplexed data signals in the TS format.

### BRIEF DESCRIPTION OF THE DRAWINGS

The accompanying drawings, which are incorporated in and constitute a part of the specification, illustrate an embodiment of the invention, and, together with the description, serve to explain the principles of the invention.

FIG. 1 is a block diagram of a TS processing apparatus according to prior art;

FIG. 2 is a block diagram of a TS processing apparatus in accordance with an embodiment of the present invention;

FIG. 3 is a block diagram of a delay-controlling apparatus using a time stamp in a digital cable broadcasting system in accordance with a first embodiment of the present invention;

FIG. 4 is a schematic of a packet having a time stamp of a signal fed into the delay-controlling apparatus shown in FIG. 3;

FIG. 5 is a schematic of a packet having a time stamp in the delay-controlling apparatus shown in FIG. 3;

FIG. 6 is a schematic showing the relationship between a valid signal and a time delay in FIG. 3;

FIG. 7 is a block diagram of a delay-controlling apparatus using an offset in a digital cable broadcasting system in accordance with a second embodiment of the present invention;

FIG. 8 is a schematic showing the relationship between a valid signal and a time delay in FIG. 7;

FIG. 9 is a block diagram of a delay-controlling apparatus using a counter in a digital cable broadcasting system in accordance with a third embodiment of the present invention;

FIG. 10 is a schematic showing an activation time and a descrambling time in FIG. 9; and

FIG. 11 is a schematic showing a counter time in FIG. 9.

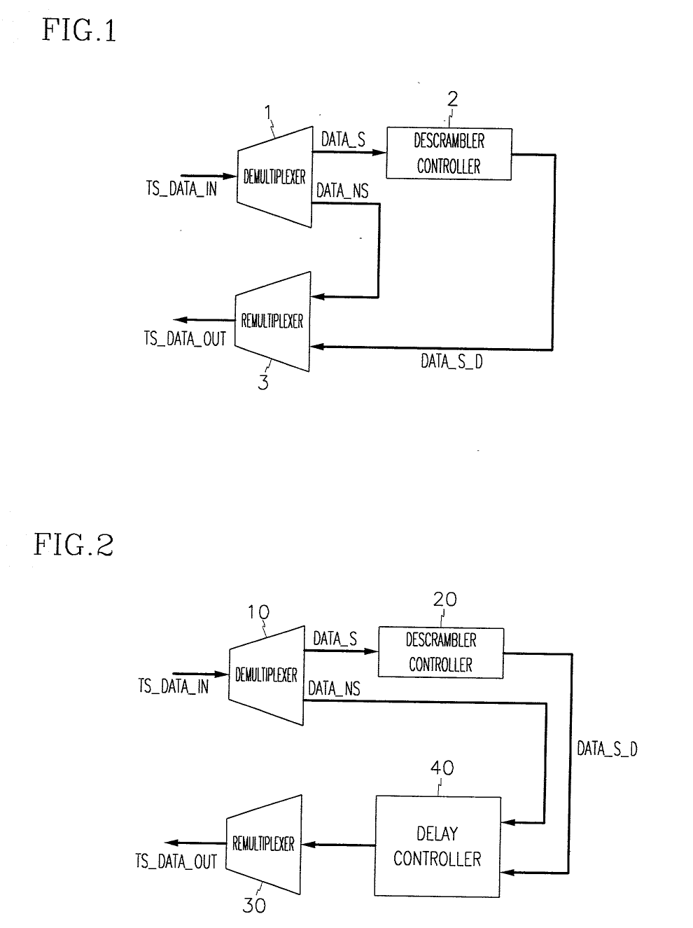

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

As illustrated in FIG. 2, an apparatus for processing a TS in a digital cable broadcasting system in accordance with an embodiment of the present invention is constructed as follows.

The apparatus that is to process a digital cable broadcasting data signal input in a TS format comprises: a demultiplexer 10 for receiving TSs and dividing them into a scrambled data signal and a non-scrambled data signal; a descrambler controller 20 for receiving the scrambled data signal from the demultiplexer 10 and descrambling it; a delay controller 40 for receiving the non-scrambled data signal from the demultiplexer 10 and the descrambled data signal from the descrambler controller 20, and delaying them by a predetermined time; and a remultiplexer 30 for receiving the data signals from the delay controller 40 and multiplexing them in the TS format.

The apparatus for processing a TS in a digital cable broadcasting system in accordance with the embodiment of the present invention operates as follows.

First, the demultiplexer 10 receives MPEG-2 TS data by 8 bits in parallel from a host (not shown).

Also, the demultiplexer 10 reads out the transport scrambling control field present in the header of the TS packet, and judges whether or not the input TS packet is scrambled.

When the TS packet is scrambled, the demultiplexer 10 sends the data to the descrambler controller 20. Otherwise, when the TS packet is not scrambled, the demultiplexer 10 sends the TS to the delay controller 40.

The descrambler controller 20 descrambles the data output from the demultiplexer 10 and sends the descrambled data to the delay controller 40, which delays the descrambled data signal output from the descrambler controller 20 and the non-scrambled data signal from the demultiplexer 10. The remultiplexer 30 converts the data signals delayed from the delay controller 40 to single TS data.

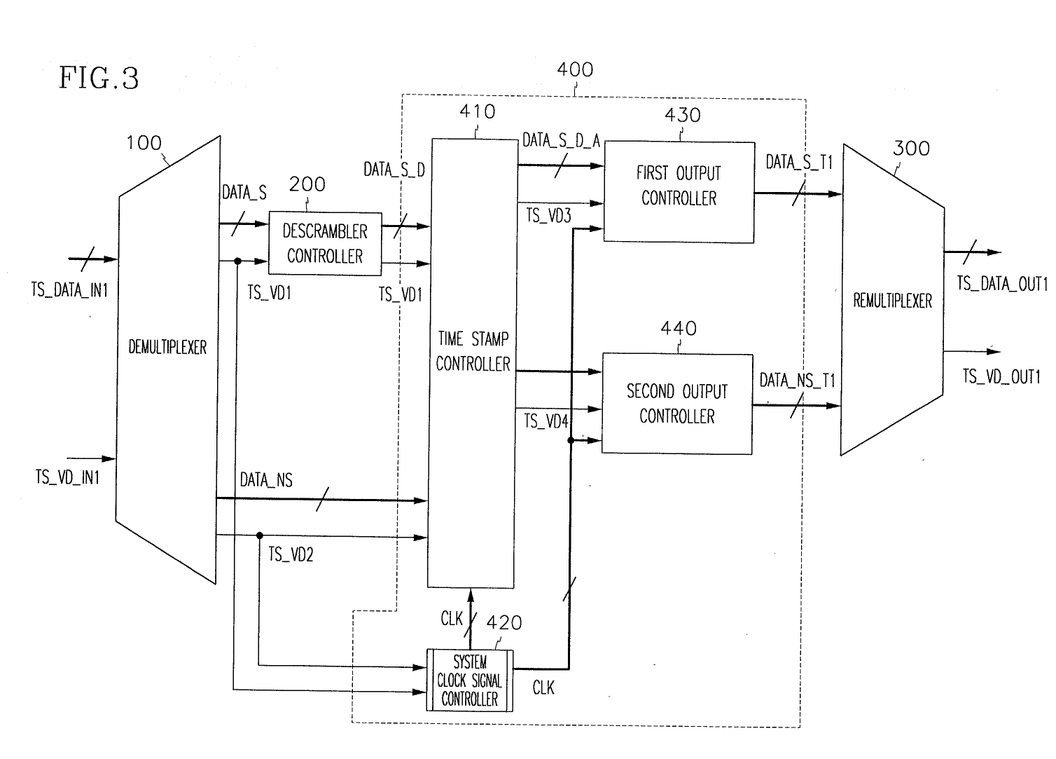

Here, the delay controller 40 may be implemented in various modifications, and its embodiments are shown in FIGS. 3, 7, and 9, respectively.

Now, a description will be given to the different embodiments of the delay controller 40 with reference to the accompanying drawings.

First, reference will be made to FIGS. 3 to 6 in the description of a first embodiment of the delay-controlling apparatus using a time stamp, in a digital cable broadcasting system.

As shown in FIG. 3, the delay-controlling apparatus 400 used in a digital cable broadcasting system according to the first embodiment of the present invention is constructed as follows.

The apparatus, which controls a delay for remultiplexing a descrambled data signal that is converted from a scrambled data signal and a non-scrambled data signal, comprises: a system clock signal controller 420 for receiving first and second valid signals from a demultiplexer 100, calculating a predetermined delay time, and generating a system time, the first and second valid signals being valid signals of the scrambled data signal and the non-scrambled data signal, respectively; a time stamp controller 410 for receiving the descrambled data signal from a descrambler controller 200, the non-scrambled data signal from the demultiplexer 100, and the TS valid signals each corresponding to the descrambled data signal and the non-scrambled data signal, and generating third and fourth valid signals and the respective data signals, the third and fourth valid signals being generated by regulating the values of the valid signals according to the system time output from the system clock signal controller 420; a first output controller 430 for sending the descrambled data signal output from the time stamp controller 410 to a remultiplexer 300 when the third valid signal output from the time stamp controller 410 is matched with the system time of the system clock signal controller 420; and a second output controller 440 for sending the non-scrambled data signal output from the time stamp controller 410 to the remultiplexer 300 when the fourth valid signal output from the time stamp controller 410 is matched with the system time of the system clock signal controller 420.

The delay-controlling apparatus used in a digital cable broadcasting system according to the first embodiment of the present invention operates as follows.

The demultiplexer 100 aligns 8-bit parallel MPEG-2 TS data output from a host (not shown) in the size of 188 sync bytes, and outputs the input TS data and their corresponding TS valid signals.

The TS valid signal, which is activated at the start time of the TS packet data and deactivated at the end time of the TS packet data, indicates the valid interval of the TS packet.

The demultiplexer 100 examines the transport scrambling control field present in the header of the TS packet to judge whether or not the TS packet is scrambled. If the TS packet is scrambled, the demultiplexer 100 sends the TS data DATA_S, and the first valid signal TS_VD1 corresponding to the TS data to the descrambler controller 200.

Otherwise, if the TS packet is not scrambled, the demultiplexer 100 sends the TS data DATA_NS and the second valid signal TS_VD2 corresponding to the TS data to the time stamp controller 410.

The system clock signal controller 420 receives the system time at which the first and second valid signals TS_VD1 and TS_VD2 of the demultiplexer 100 are activated, and calculates a predetermined delay time to generate a system time.

Now, the operation of the system clock signal controller 420 will be described in detail with reference to FIG. 6.

Upon receiving the first valid signal TS_VD1, the system clock signal controller 420 determines a delay time T_{delay} as a time value greater than a time T_{dsc} required for the descrambler controller's descrambling the TS packet at a system time T₁ of receiving the first valid signal, and sends it to the time stamp controller 410.

For a system using a 10 MHz system clock, for example, the delay time T_{delay} is desirably set as about 20 clocks.

Upon receiving the second valid signal TS_VD2, the system clock signal controller 420 adds the delay time T_{delay} to a system time T₂ of receiving the second valid signal, and sends the result to the time stamp controller 410.

Also, the system clock signal controller 420 provides a current system time for the first output controller 430 processing the descrambled TS data, and the second output controller 440 processing the non-scrambled TS data.

The descrambler controller 200 descrambles the scrambled TS data signal output from the demultiplexer 100 to generate descrambled TS data.

The time stamp controller 410 adds the 32-bit time delay signal T_{delay} output from the system clock signal controller 420 to the scrambled TS data or the non-scrambled TS data output from the demultiplexer 100.

Namely, the time stamp controller 410 sends the descrambled TS data DATA_S D_A with the third valid signal TS_VD3 to the first output controller 430, and the non-scrambled TS data DATA_NS_A with the fourth valid signal TS_VD4 to the second output controller 440.

Thus the descrambled TS data DATA_S_D_A and the non-scrambled TS data DATA_NS_A are aligned as shown in (A) of FIG. 5, and the third and fourth valid signals TS_VD3 and TS_VD4 are aligned as shown in (B) of FIG. 5.

In (A) of FIG. 5, 4-byte time information is added ahead of the 188-byte MPEG-2 TS data. The third valid signal TS_VD3 represents the valid interval of the descrambled TS data, and the fourth valid signal TS_VD4 represents the valid interval of the non-scrambled TS data.

The first output controller 430 for processing the descrambled TS data receives the descrambled TS data with 32-bit time information from the time stamp controller 410, and stores them in a built-in memory (not shown).

Then the first output controller 430 sends the stored TS data to the remultiplexer 300 when the 32-bit time information of the TS data is matched with the system time CLK of the system clock signal controller 420.

On the other hand, the second output controller 440 for processing the non-scrambled TS data receives the non-scrambled TS data with 32-bit time information from the time stamp controller 410, and stores them in a built-in memory (not shown).

Then the second output controller 440 sends the stored TS data to the remultiplexer 300 when the 32-bit time information of the TS data is matched with the system time of the system clock signal controller 420.

The remultiplexer 300 receives the descrambled TS data and the non-scrambled TS data from the first and second output controllers 430 and 440, respectively, and generates the single TS data and the corresponding TS valid signals, which are aligned as shown in (A) and (B) of FIG. 5.

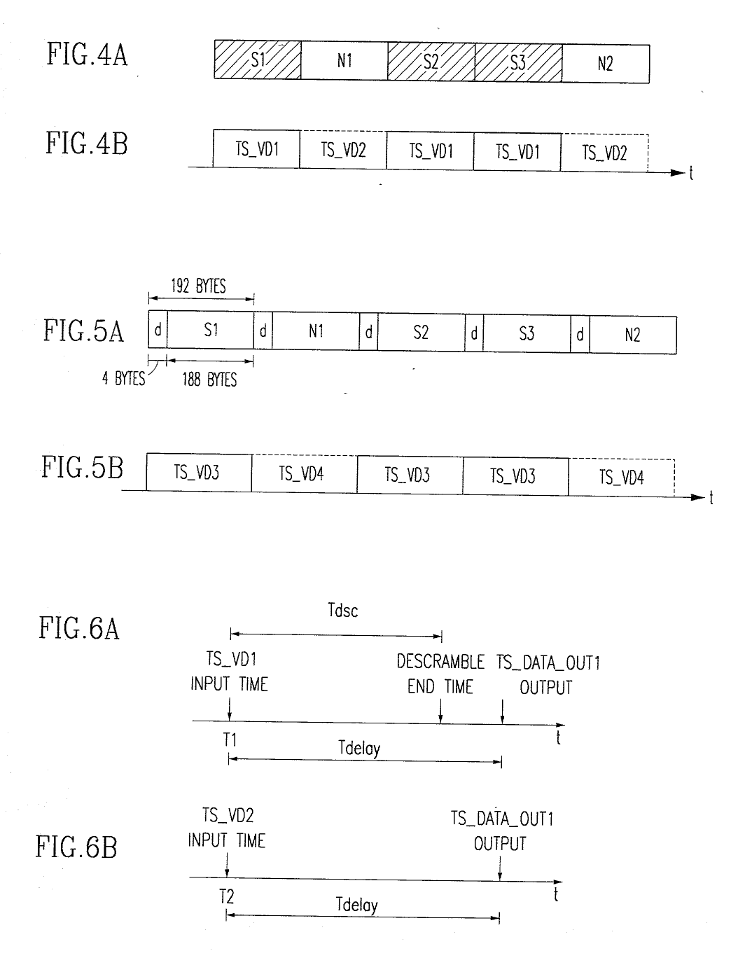

Referring to FIG. 4, there are shown 188-byte MPEG-2 TS data among which S1, S2, and S3 represent the scrambled TS packet data, with N1 and N2 representing the non-scrambled TS packet data.

The first valid signal TS_VD1 indicates the valid interval of the scrambled TS data, and the second valid signal TS_VD2 indicates the valid interval of the non-scrambled TS data.

FIG. 6 is a diagram showing the relationship among the valid signals and the time delay T_{delay} according to the present invention, in which (A) shows the relationship between the valid signal and the time delay T_{delay} in the case of receiving the descrambled TS data, and (B) shows the relationship between the valid signal and the time delay T_{delay} in the case of receiving the non-scrambled TS data.

As described above, the first embodiment uses the time stamp to assign a predetermined delay value to all the TS packets fed into the demultiplexer 100 in the POD module, irrespective of whether the TS packets are scrambled.

For this purpose, the system clock signal controller 420 informs the time stamp controller 410 of the time delay to be assigned after receiving the valid signal from the demultiplexer 100.

Namely, the time stamp controller 410 sends to the remultiplexer 300 the packets to be processed at the time informed by the system clock signal controller 420 so as to assign a predetermined time delay to all the TS packet data.

The use of the time stamp enables assigning a predetermined delay to all the input TS packets and delaying the TS packets without an error even when the 188-byte TS packets are received before descrambling the scrambled data.

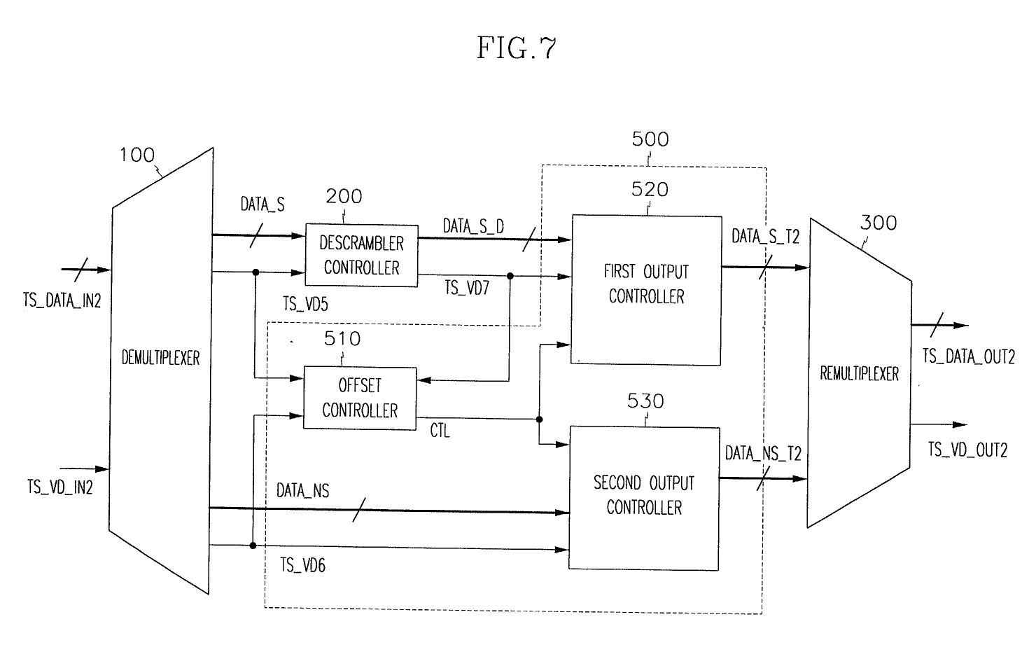

Though the first embodiment realizes the delay-controlling apparatus using the time stamp, FIG. 7 shows a delay-controlling apparatus using an offset in accordance with a second embodiment of the present invention.

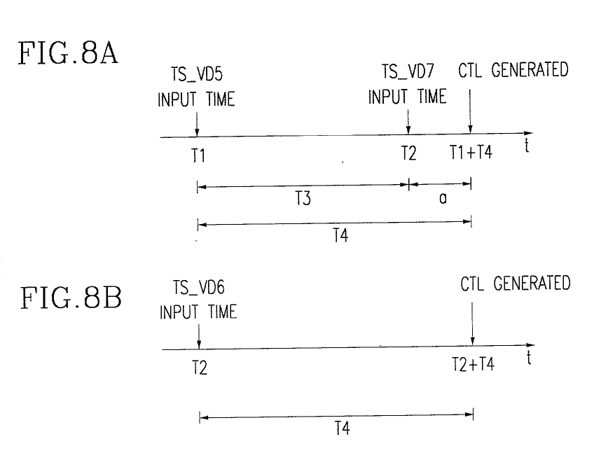

Referring to FIGS. 7 and 8, the second embodiment of the delay-controlling apparatus using an offset in a digital cable broadcasting system will be described.

As shown in FIG. 7, the delay-controlling apparatus 500 used in a digital cable broadcasting system according to the second embodiment of the present invention is constructed as follows.

The apparatus, which controls a delay for remultiplexing a descrambled data signal that is converted from a scrambled data signal, and a non-scrambled data signal, comprises: an offset controller 510 for receiving first and second valid signals, calculating a predetermined offset time according to a required time for descrambling using a third valid signal, and generating a system time, the first and second valid signals being valid signals of the scrambled data signal and the non-scrambled data signal, respectively, and the third valid signal being a valid signal of the descrambled data signal; a first output controller 520 for storing the descrambled data signal, and sending it to the remultiplexer 300 when the third valid signal is matched with the system time output from the offset controller 510; and a second output controller 530 for storing the non-scrambled data signal, and sending it to the remultiplexer 300 when the second valid signal is matched with the system time output from the offset controller 510.

The delay-controlling apparatus used in a digital cable broadcasting system according to the second embodiment of the present invention operates as follows.

The demultiplexer 100 aligns 8-bit parallel MPEG-2 TS data output from a host (not shown) in the size of 188 sync bytes, and receives the TS data and the TS valid signal TS_VD_IN2.

The TS valid signal, which is activated at the start time of the TS packet data TS_DATA_IN2 and deactivated at the end time of the TS packet data TS_DATA_IN2, indicates the valid interval of the TS packet.

The demultiplexer 100 examines the transport scrambling control field present in the header of the TS packet to judge whether or not the TS packet is scrambled. If the TS packet is scrambled, the demultiplexer 100 sends the TS data DATA_S and the first valid signal TS_VD5 corresponding to the TS data to the descrambler controller 200. Otherwise, if the TS packet is not scrambled, the demultiplexer 100 sends the TS data DATA_NS and the second valid signal TS_VD6 corresponding to the TS data to the second output controller 530.

At the same time, the demultiplexer 100 sends the first and second valid signals TS_VD5 and TS_VD6 corresponding to the respective packets to the offset controller 510.

The offset controller 510 receives the system time at which the first and second valid signals TS_VD5 and TS_VD6 are activated.

Now, the operation of the offset controller 510 will be described in detail with reference to FIG. 8.

In FIG. 8, (A) shows the relationship among the first valid signal TS_VD5, the third valid signal TS_VD7, and the output signal in the case of receiving the scrambled TS data; and (B) shows the relationship between the second valid signal TS_VD6 and the output signal in the case of receiving the non-scrambled TS data.

Upon receiving the first valid signal TS_VD5, the offset controller 510 memorizes a system time T₁ at which the valid signal is received, detects a system time T₂ at which the third valid signal TS_VD7 is received from the descrambler controller 200, and calculates T3 (=T₂−T₁).

The offset controller 510 adds a constant α to T₃ to calculate T₄ (=T₃+α), and sends the output signal to the first output controller 520 when the system time is matched with T₄.

Also, the offset controller 510 adds T₄ to the system time at which the second valid signal TS_VD6 is received, and sends the resulting value to the second output controller 530.

If the second valid signal TS_VD6 is received before the calculation of T₃, i.e., if the non-scrambled TS data are received first, the offset controller 510 sets T₄ as 20 system clocks for delay assignment. Otherwise, if the first valid signal TS_VD5 is received, i.e., if the scrambled TS data are received first, the offset controller 510 recalculates T₃ to set T₄.

After this, the offset controller 510 recalculates T₃ whenever the first valid time TS_VD5 is received, to change information about the output signal to be sent to the first and second output controllers 520 and 530.

The descrambler controller 200 descrambles the scrambled TS data and sends the descrambled TS data to the first output controller 520.

The first output controller 520 for processing the descrambled TS data stores the TS data received from the descrambler controller 200, and sends them to the remultiplexer 300 upon receiving the output signal of the offset controller 510.

The second output controller 530 for processing the non-scrambled TS data stores the TS data received from the demultiplexer 100, and sends them to the remultiplexer 300 upon receiving the output signal of the offset controller 510.

The remultiplexer 300 receives the descrambled TS data and the non-scrambled TS data from the first and second output controllers 520 and 530, respectively, and generates single TS data and the corresponding TS valid signals.

As described above, the second embodiment calculates a required time for the offset controller's descrambling of the scrambled TS packets, and thereby assigns a predetermined delay to all the TS packets fed into the demultiplexer 100, irrespective of whether or not the TS packets are scrambled.

For this purpose, the offset controller 510 receives the valid signals from the demultiplexer 100 and the descrambler controller 200, and calculates the difference between the valid signals on the basis of the system time.

The first and second output controllers 520 and 530 for processing the TS data assign a predetermined delay to all the TS packet data by sending the TS data to the remultiplexer 300 at the output time received from the offset controller 510.

The use of the offset controller 510 enables assigning a predetermined delay to all the input TS packets and delaying the TS packets without an error, even when the time required for the descrambler controller 200 to descramble the scrambled TS data is variable within a range.

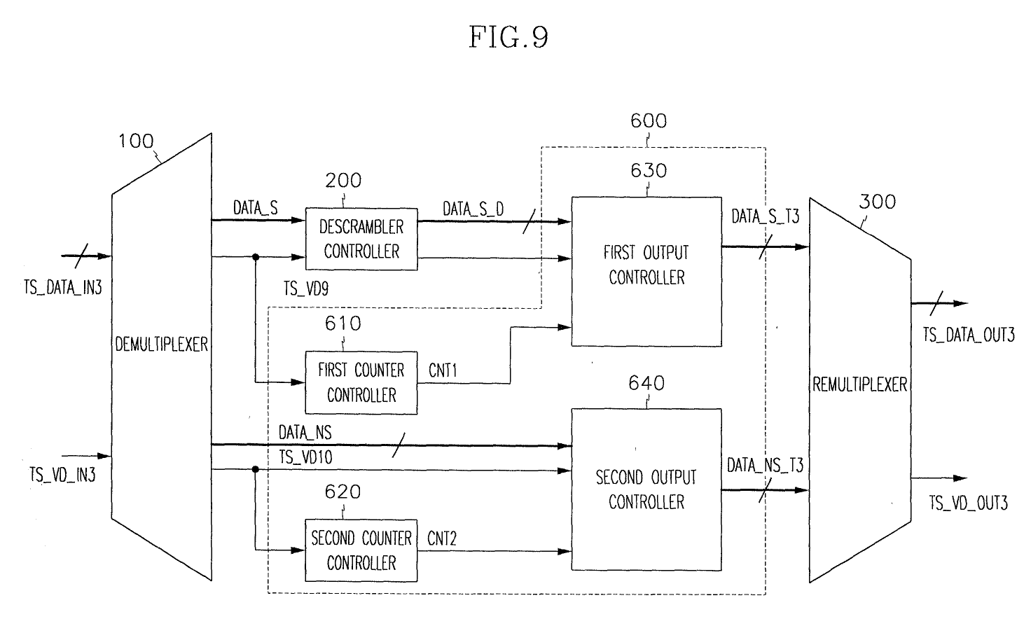

Now, a description will be given to a third embodiment of the delay-controlling apparatus using a counter in a digital cable broadcasting system with reference to FIGS. 9, 10, and 11.

As shown in FIG. 9, the delay-controlling apparatus 600 used in a digital cable broadcasting system according to the third embodiment of the present invention is constructed as follows.

The apparatus, which controls a delay for remultiplexing a descrambled data signal DATA_S_D that is converted from a scrambled data signal DATA_S, and a non-scrambled data signal DATA_NS, comprises: a first counter controller 610 for receiving a first valid signal TS_VD9, counting for a predetermined time, and generating a first count end signal CNT1 indicating the end of counting, the first valid signal being a valid signal of the scrambled data signal DATA_S; a second counter controller 620 for receiving a second valid signal TS_VD10, counting for a predetermined time, and generating a second count end signal CNT2 indicating the end of counting, the second valid signal being a valid signal of the non-scrambled data signal DATA_NS; a first output controller 630 for storing the descrambled data signal DATA_S_D, and sending it to the remultiplexer 300 when the first count end signal CNT1 is received from the first counter 610; and a second output controller 640 for storing the non-scrambled data signal DATA_NS, and sending it to the remultiplexer 300 when the second count end signal CNT2 is received from the second counter controller 620.

The delay-controlling apparatus used in a digital cable broadcasting system according to the third embodiment of the present invention operates as follows.

The demultiplexer 100 aligns 8-bit parallel MPEG-2 TS data output from a host (not shown) in the size of 188 sync bytes, and receives the TS data TS_DATA_IN3 and the TS valid signal TS_VD_IN3.

The TS valid signal TS_VD_IN3, which is activated at the start time of the TS packet data and deactivated at the end time of the TS packet data, indicates the valid interval of the TS packet.

The demultiplexer 100 examines the transport scrambling control field present in the header of the TS packet to judge whether or not the TS packet is scrambled. If the TS packet is scrambled, the demultiplexer 100 sends the TS data DATA_S and the first valid signal TS_VD9 corresponding to the TS data to the descrambler controller 200. Otherwise, if the TS packet is not scrambled, the demultiplexer 100 sends the TS data DATA_NS and the second valid signal TS_VD10 corresponding to the TS data to the first output controller 630.

At the same time, the demultiplexer 100 sends the first valid signal TS_VD9 corresponding to the scrambled TS packet to the first counter controller 610, and the second valid signal TS_VD10 corresponding to the non-scrambled TS packet to the second counter controller 620.

The descrambler controller 200 descrambles the scrambled TS data DTA_S and sends the descrambled TS data DATA_S_D to the first output controller 630.

The first and second counter controllers 610 and 620 process the first and second valid signals TS_VD9 and TS_VD10 received from the demultiplexer 100, respectively.

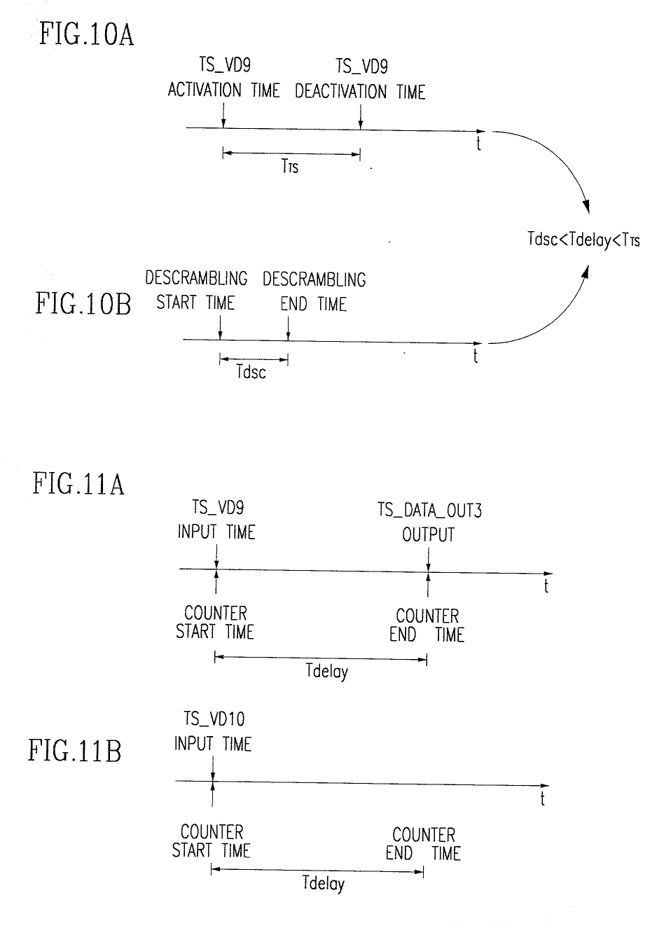

Now, a description will be given to the functions of the first and second counter controllers 610 and 620 with reference to FIGS. 10 and 11.

FIG. 10 shows the relationship among T_{TS}, T_{dsc}, and T_{delay}; and FIG. 11 shows the relationship between the valid signal and the counter operating time.

Upon receiving the first valid signal TS_VD9, the first counter controller 610 counts for a time T_{delay} that is shorter than a time T_{TS} of receiving 188 bytes and longer than a time T_{dsc} of descrambling the TS data at the descrambler controller 200.

For a system using a 10 MHz system clock, for example, the counter value is desirably determined as about 20 clocks. The first counter controller 610 sends the first count end signal CNT1 when the counter value ends.

Upon receiving the second valid signal TS_VD10, the second counter controller 620 counts for a time T_{delay} that is shorter than the time T_{TS} of receiving 188 bytes and longer than the time T_{dsc} of descrambling the TS data at the descrambler controller 200.

For a system using a 10 MHz system clock, for example, the counter value is desirably determined as about 20 clocks. The second counter controller 620 sends the second count end signal CNT2 when the counter value ends.

The first output controller 630 stores the descrambled TS data DATA_S_D received from the descrambler controller 200 in a built-in memory and waits for the first count end signal CNT1 from the first counter controller 610.

Upon receiving the first count end signal CNT1, the first output controller 630 sends the stored ST data DATA_S_T3 to the remultiplexer 300.

On the other hand, the second output controller 640 stores the non-scrambled TS data DATA_NS received from the demultiplexer 100 in a built-in memory and waits for the second count end signal CNT2 from the second counter controller 620.

Upon receiving the second count end signal CNT2, the second output controller 640 sends the stored ST data DATA_NS_T3 to the remultiplexer 300.

The remultiplexer 300 receives the descrambled TS data and the non-scrambled TS data from the first and second output controllers 630 and 640, respectively, and generates the single TS data TS_DATA_OUT3 and the corresponding TS valid signal TS_VD_OUT3.

As described above, the third embodiment uses a counter to assign a predetermined delay to all TS packets fed into the demultiplexer 100, irrespective of whether or not the TS packets are scrambled.

For this purpose, the counter controllers 610 and 620 receive the valid signals of the input TS packets, count for a predetermined time that is shorter than a time of receiving 188 bytes and longer than a time of descrambling the TS packets at the descrambler controller 200, and send the count end signals to the output controllers 630 and 640 at the end of the counter.

Also, the output controllers make it possible to assign a predetermined delay to all TS packets fed into the demultiplexer 100 by receiving the count end signals and sending the corresponding TS packet data to the remultiplexer 300 at the same time.

Accordingly, the present invention can assign a predetermined delay time longer than a required time for the descrambler controller's data descrambling of all the MPEG-2 TS data fed into a POD module through in-band channels in a digital cable broadcasting system, irrespective of whether the TS data are scrambled, thereby solving the problem during the decoding process.

The present invention also assigns a predetermined delay to all the input TS data irrespective of whether the TS data are scrambled, and thereby eliminates a need of changing the PCR value in the POD module.

In particular, the time stamp method using the system time as proposed in the first embodiment of the present invention assigns a predetermined delay without an error, even when the time delay caused during the descrambling process is longer than the time of receiving 188-byte TS packets.

The use of an input/output offset value of the descrambler in the second embodiment of the present invention assigns an optimized delay time to all the input TS data even when the required descrambling time is variable.

Furthermore, the use of a counter in the third embodiment of the present invention assigns a predetermined delay time to all the input TS data without increasing the complexity of implementation.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. An apparatus for processing a transport stream (TS) in a digital cable broadcasting system, said apparatus to process a digital cable broadcasting data signal received in a TS format, the apparatus comprising:
a demultiplexer for receiving TSs, dividing them into a scrambled data signal and a non-scrambled data signal, and outputting the divided data signals;
a descrambler controller for receiving the scrambled data signals from the demultiplexer, descrambling them, and outputting the descrambled data signals;
a delay controller for receiving the non-scrambled data signal from the demultiplexer and the descrambled data signal from the descrambler controller, delaying them by a predetermined time, and outputting the delayed data signals; and
a remultiplexer for receiving the data signals from the delay controller, multiplexing them, and outputting the multiplexed data signals in the TS format.

2. The apparatus as claimed in claim 1, wherein the delay controller comprises:
a system clock signal controller for receiving first and second valid signals, calculating a predetermined delay time and generating a system time, the first and second valid signals being valid signals of the scrambled data signal and the non-scrambled data signal output from the demultiplexer, respectively;
a time stamp controller for receiving the descrambled data signal from the descrambler controller, the non-scrambled data signal from the demultiplexer, and the TS valid signals corresponding to the descrambled data signal and the non-scrambled data signal, and generating third and fourth valid signals and their respective data signals, the third and fourth valid signals being generated by regulating the values of the corresponding valid signals according to the system time output from the system clock signal controller;
a first output controller for sending the descrambled data signal output from the time stamp controller to the remultiplexer when the third valid signal output from the time stamp controller is matched with the system time output from the system clock signal controller; and
a second output controller for sending the non-scrambled data signal output from the time stamp controller to the remultiplexer when the fourth valid signal output from the time stamp controller is matched with the system time output from the system clock signal controller.

3. The apparatus as claimed in claim 2, wherein the system clock signal controller calculates the delay time as a value greater than a time required for the descrambler controller's descrambling signals.

4. The apparatus as claimed in claim 1, wherein the delay controller comprises:
an offset controller for receiving first and second valid signals, calculating a predetermined offset time according to a required descrambling time using a third valid signal, and outputting the predetermined offset time as a system time, the first and second valid signals being valid signals of the scrambled data signal and the non-scrambled data signal output from the demultiplexer, respectively, the third valid signal being a valid signal of the descrambled data signal output from the descrambler controller;
a first output controller for storing the descrambled data signal output from the descrambler controller, and sending it to the remultiplexer when the third valid signal is matched with the system time output from the offset controller; and
a second output controller for storing the non-scrambled data signal output from the demultiplexer, and sending it to the remultiplexer when the second valid signal is matched with the system time output from the offset controller.

5. The apparatus as claimed in claim 4, wherein the offset controller calculates the offset time using the difference between the output times of the first and third valid signals.

6. The apparatus as claimed in claim 1, wherein the delay controller comprises:
a first counter controller for receiving a first valid signal, counting for a predetermined time, and generating a first count end signal at the end of counting, the first valid signal being a valid signal of the scrambled data signal output from the demultiplexer;
a second counter controller for receiving a second valid signal, counting for a predetermined time, and generating a second count end signal at the end of counting, the second valid signal being a valid signal of the non-scrambled data signal output from the demultiplexer;
a first output controller for storing the descrambled data signal output from the descrambler controller, and outputting it upon receiving the first count end signal from the first counter controller; and
a second output controller for storing the non-scrambled data signal output from the demultiplexer, and outputting it upon receiving the second count end signal from the second counter controller.

7. The apparatus as claimed in claim 6, wherein the predetermined time for the first counter controller's counting is shorter than a TS data receiving time and longer than a descrambling time.

8. The apparatus as claimed in claim 6, wherein the predetermined time for the second counter controller's counting is shorter than a TS data receiving time and longer than a descrambling time.

9. The apparatus as claimed in claim 1, wherein the demultiplexer divides the input TSs into a scrambled data signal and a non-scrambled data signal by using information about a transport scrambling control field.

10. An apparatus for controlling a delay in a digital cable broadcasting system, said apparatus to control the delay for remultiplexing a descrambled data signal that is converted from a scrambled data signal, and a non-scrambled data signal, the apparatus comprising:
a system clock signal controller for receiving first and second valid signals, calculating a predetermined delay time, and generating a system time, the first and second valid signals being valid signals of the scrambled data signal and the non-scrambled data signal, respectively;
a time stamp controller for receiving the descrambled data signal, the non-scrambled data signal and TS valid signals corresponding to the descrambled data signal and the non-scrambled data signal, and generating third and fourth valid signals and the respective data signals, the third and fourth valid signals being generated by regulating the values of the corresponding valid signals according to the system time output from the system clock signal controller;
a first output controller for outputting the descrambled data signal received from the time stamp controller when the third valid signal output from the time stamp controller is matched with the system time output from the system clock signal controller; and
a second output controller for outputting the non-scrambled data signal received from the time stamp controller when the fourth valid signal output from the time stamp controller is matched with the system time output from the system clock signal controller.

11. The apparatus as claimed in claim 10, wherein the system clock signal controller calculates the delay time as a value greater than a time required for descrambling the signal.

12. An apparatus for controlling a delay in a digital cable broadcasting system, said apparatus to control the delay for remultiplexing a descrambled data signal that is converted from a scrambled data signal, and a non-scrambled data signal, the apparatus comprising:
an offset controller for receiving first and second valid signals, calculating a predetermined offset time according to a required descrambling time using a third valid signal, and outputting the predetermined offset time as a system time, the first and second valid signals being valid signals of the scrambled data signal and the non-scrambled data signal, respectively, the third valid signal being a valid signal of the descrambled data signal;
a first output controller for storing the descrambled data signal, and outputting it when the third valid signal is matched with the system time output from the offset controller; and
a second output controller for storing the non-scrambled data signal, and outputting it when the second valid signal is matched with the system time output from the offset controller.

13. The apparatus as claimed in claim 12, wherein the offset controller calculates the offset time using the difference between the output times of the first and third valid signals.

14. An apparatus for controlling a delay in a digital cable broadcasting system, said apparatus to control the delay for remultiplexing a descrambled data signal that is converted from a scrambled data signal, and a non-scrambled data signal, the apparatus comprising:
a first counter controller for receiving a first valid signal, counting for a predetermined time, and generating a first count end signal at the end of counting, the first valid signal being a valid signal of the scrambled data signal;
a second counter controller for receiving a second valid signal, counting for a predetermined time, and generating a second count end signal at the end of counting, the second valid signal being a valid signal of the non-scrambled data signal;
a first output controller for storing the descrambled data signal, and outputting it upon receiving the first count end signal from the first counter controller; and
a second output controller for storing the non-scrambled data signal, and outputting it upon receiving the second count end signal from the second counter controller.

15. The apparatus as claimed in claim 14, wherein the predetermined time for the first counter controller's counting is shorter than a TS data receiving time and longer than a descrambling time.

16. The apparatus as claimed in claim 14, wherein the predetermined time for the second counter controller's counting is shorter than a TS data receiving time and longer than a descrambling time.

17. A method for processing a TS in a digital cable broadcasting system, said method demultiplexing a digital cable broadcasting data signal received in a TS format, descrambling a scrambled signal, and remultiplexing the descrambled signal in the TS format, the method comprising:
(a) receiving TSs and dividing them into a scrambled data signal and a non-scrambled data signal;
(b) receiving the scrambled data signal, descrambling it, and outputting the descrambled data signal;
(c) receiving the non-scrambled data signal and the descrambled data signal, delaying them by a predetermined time, and outputting the delayed data signals; and
(d) receiving the delayed data signals, multiplexing them, and outputting the multiplexed data signals in the TS format.

18. The method as claimed in claim 17, wherein the step (c) comprises:
receiving first and second valid signals, calculating a predetermined delay time and generating a system time, the first and second valid signals being valid signals of the scrambled data signal and the non-scrambled data signal, respectively;
receiving the descrambled data signal, the non-scrambled data signal, and the TS valid signals corresponding to the descrambled data signal and the non-scrambled data signal, and generating third and fourth valid signals and their respective data signals, the third and fourth valid signals being generated by regulating the values of the corresponding valid signals according to the system time;
storing the descrambled data signal, and outputting it when the third valid signal is matched with the system time; and
storing the non-scrambled data signal, and outputting it when the fourth valid signal is matched with the system time.

19. The method as claimed in claim 17, wherein the step (c) comprises:
receiving first and second valid signals, calculating a predetermined offset time according to a required descrambling time using a third valid signal, and generating the predetermined offset time as a system time, the first and second valid signals being valid signals of the scrambled data signal and the non-scrambled data signal, respectively, the third valid signal being a valid signal of the descrambled data signal;
storing the descrambled data signal, and outputting it when the third valid signal is matched with the system time; and
storing the non-scrambled data signal, and outputting it when the second valid signal is matched with the system time.

20. The method as claimed in claim 17, wherein the step (c) comprises:
receiving a first valid signal, counting for a predetermined time, and generating a first count end signal at the end of counting, the first valid signal being a valid signal of the scrambled data signal;
receiving a second valid signal, counting for a predetermined time, and generating a second count end signal at the end of counting, the second valid signal being a valid signal of the non-scrambled data signal;
storing the descrambled data signal, and outputting it upon receiving the first count end signal; and
storing the non-scrambled data signal, and outputting it upon receiving the second count end signal.
